(19) United States
(12) Patent Application Publication
(10) Pub. No.: US 2013/0071581 A1
(43) Pub. Date: Mar. 21, 2013

(54) PLASMA MONITORING AND MINIMIZING STRAY CAPACITANCE

(71) Applicants: Jonghoon Baek, San Jose, CA (US); Sam H. Kim, San Ramon, CA (US); Beom Soo Park, San Jose, CA (US); John M. White, Hayward, CA (US); Shinichi Kunita, San Jose, CA (US); Hsiao-Lin Yang, San Jose, CA (US)

(72) Inventors: Jonghoon Baek, San Jose, CA (US); Sam H. Kim, San Ramon, CA (US); Beom Soo Park, San Jose, CA (US); John M. White, Hayward, CA (US); Shinichi Kunita, San Jose, CA (US); Hsiao-Lin Yang, San Jose, CA (US)

(21) Appl. No.: 13/622,955

(22) Filed: Sep. 19, 2012

Related U.S. Application Data
(60) Provisional application No. 61/536,760, filed on Sep. 20, 2011.

(51) Int. Cl. H05H 1/46

(52) U.S. Cl. CPC H05H 1/46
USPC 427/569; 315/111.21

(57) ABSTRACT

The present invention generally relates to a capacitively coupled plasma (CCP) processing chamber, a manner to reduce or prevent stray capacitance, and a manner to measure plasma conditions within the processing chamber. As CCP processing chambers increase in size, there is a tendency for stray capacitance to negatively impact the process. Additionally, RF ground straps may break. By increasing the spacing between the chamber backing plate and the chamber wall, stray capacitance may be minimized. Additionally, the plasma may be monitored by measuring the conditions of the plasma at the backing plate rather than at the match network. In so measuring, the plasma harmonic data may be analyzed to reveal plasma processing conditions within the chamber.

### CROSS-REFERENCE TO RELATED APPLICATIONS

This application claims benefit of U.S. Provisional Patent Application Ser. No. 61/536,760 (APPM/14722L), filed Sep. 20, 2012, which is herein incorporated by reference.

### BACKGROUND OF THE INVENTION

1. Field of the Invention

Embodiments of the present invention generally relate to a capacitively coupled plasma (CCP) processing chamber, a manner to reduce or prevent stray capacitance, and a manner to measure plasma conditions within the processing chamber.

2. Description of the Related Art

Most, if not all, computers and televisions manufactured are flat panel displays (FPDs). Some of the FPDs are quite large and almost all FPDs are larger than a semiconductor chip that is used in the modern personal computer. To manufacture the FPDs, large area processing chambers (i.e., processing chambers sized to process substrates having a surface area of greater than about 1600 cm²) are oftentimes utilized rather than the smaller chambers (i.e., sized to process substrates having a diameter of up to about 450 mm) typically utilized to manufacture semiconductor chips. The large area processing chambers are sized to process a large area substrate that may later be sliced into several FPDs.

One type of large area processing chamber is a plasma enhanced chemical vapor deposition (PECVD) processing chamber. There are several types of PECVD chambers available such as inductively coupled plasma (ICP) chambers and CCP chambers. For CCP chambers, RF current is applied to one electrode that ignites processing gas into a plasma that deposits material onto a substrate. The RF current applied to the electrode seeks to return to the source driving the RF current, which is oftentimes referred to as RF grounding or RF return. RF grounding is a source of many problems in a CCP processing chamber such as stray capacitance and difficulty in monitoring the plasma.

Therefore, there is a need in the art for an effective manner to monitor the plasma in a CCP chamber and to limit stray capacitance.

### SUMMARY OF THE INVENTION

The present invention generally relates to a CCP processing chamber, a manner to reduce or prevent stray capacitance, and a manner to measure plasma conditions within the processing chamber. As CCP processing chambers increase in size, there is a tendency for stray capacitance to negatively impact the process. Additionally, RF ground straps may break. By increasing the spacing between the chamber backing plate and the chamber wall, stray capacitance may be minimized. Additionally, the plasma may be monitored by measuring the conditions of the plasma at the backing plate rather than at the match network. In so measuring, the plasma harmonic data may be analyzed to reveal plasma processing conditions within the chamber.

In one embodiment, an apparatus includes a chamber body sized to process a substrate having a surface area of greater than about 1600 cm², a chamber lid coupled to the chamber body, an isolator plate coupled to the chamber lid, the isolator plate having a thickness of greater than 0.190 inches, and a backing plate coupled to the isolator plate.

In another embodiment, a method includes delivering RF power from an RF power source through a match network to a capacitively coupled plasma chamber, igniting a plasma within the capacitively coupled plasma chamber and detecting a condition of the plasma by measuring a plasma parameter at a location spaced from the match network.

In another embodiment, a method comprises delivering RF power from an RF power source through a match network to a backing plate of a capacitively coupled plasma chamber; igniting a plasma within the capacitively coupled plasma chamber; and measuring one or more of second and third harmonics of the plasma at a location spaced from the match network.

In another embodiment, a plasma enhanced chemical vapor deposition method comprises igniting a plasma within a plasma enhanced chemical vapor deposition chamber, the chamber comprising a matching network, a backing plate and a gas distribution showerhead; and measuring at least one or second and third harmonics of the plasma generated within the chamber, the measuring occurring at the backing plate.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a cross sectional view of a PECVD apparatus according to one embodiment of the invention.

FIG. 2 is a schematic illustration of a backing plate coupled to a showerhead.

FIG. 3 is a graph showing the sensitivity of the second harmonic in measuring plasma conditions.

FIG. 4 is a graph showing the insensitivity of the fundamental frequency in measuring plasma conditions.

FIG. 5 is a flow chart showing for a method of measuring plasma conditions according to one embodiment.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

The present invention generally relates to a CCP processing chamber, a manner to reduce or prevent stray capacitance, and a manner to measure plasma conditions within the processing chamber. As CCP processing chambers increase in size, there is a tendency for stray capacitance to negatively impact the process. Additionally, RF ground straps may break. By increasing the spacing between the chamber backing plate and the chamber wall, stray capacitance may be minimized. Additionally, the plasma may be monitored by measuring the conditions of the plasma at the backing plate rather than at the match network. In so measuring, the plasma harmonic data may be analyzed to reveal plasma processing conditions within the chamber.

Embodiments discussed herein may be practiced in a PECVD chamber available from AKT America, a subsidiary of Applied Materials, Inc., Santa Clara, Calif. It is to be understood that the embodiments discussed herein may be practiced in other processing systems, including those sold by other manufacturers.

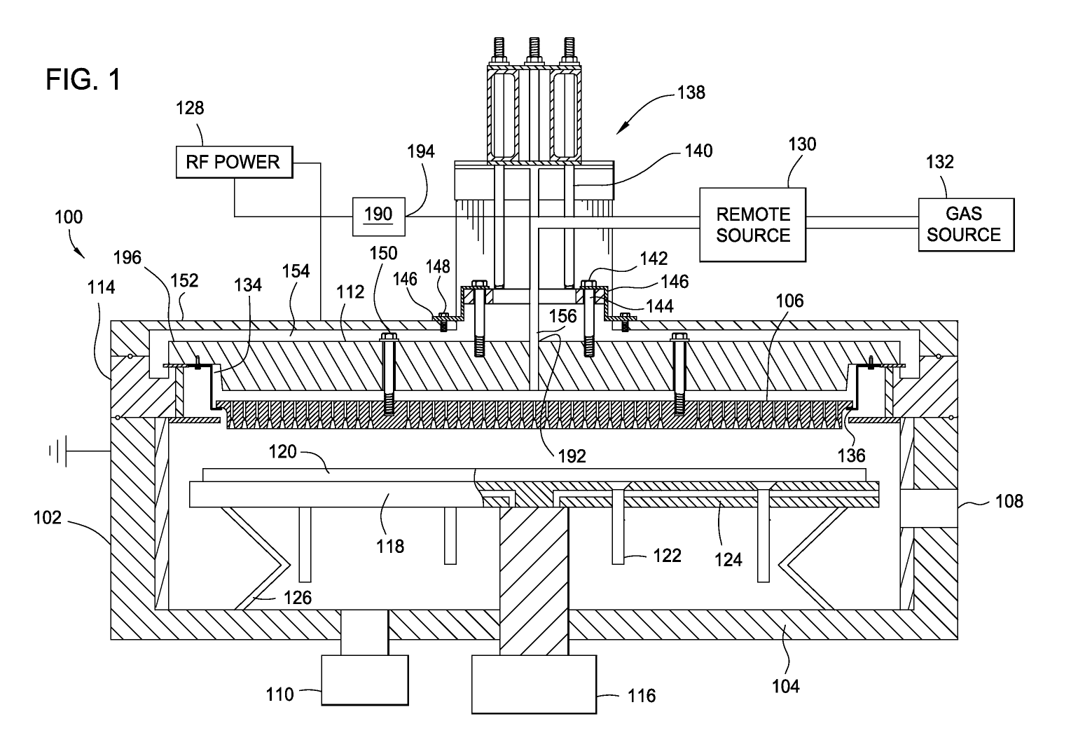

FIG. 1 is a cross sectional view of a PECVD apparatus according to one embodiment of the invention. The apparatus includes a chamber 100 in which one or more films may be deposited onto a substrate 120. The chamber 100 generally includes walls 102, a bottom 104 and a showerhead 106 which define a process volume. A substrate support 118 is disposed within the process volume. The process volume is accessed through a slit valve opening 108 such that the substrate 120 may be transferred in and out of the chamber 100. The substrate support 118 may be coupled to an actuator 116 to raise and lower the substrate support 118. Lift pins 122 are moveably disposed through the substrate support 118 to move a substrate to and from the substrate receiving surface. The substrate support 118 may also include heating and/or cooling elements 124 to maintain the substrate support 118 at a desired temperature. The substrate support 118 may also include RF return straps 126 to provide an RF return path at the periphery of the substrate support 118 to the chamber bottom 104 or walls 102.

The showerhead 106 is coupled to a backing plate 112 by a fastening mechanism 150. The showerhead 106 may be coupled to the backing plate 112 by one or more fastening mechanisms 150 to help prevent sag and/or control the straightness/curvature of the showerhead 106. In one embodiment, twelve fastening mechanisms 150 may be used to couple the showerhead 106 to the backing plate 112. The fastening mechanisms 150 may include a nut and bolt assembly. In one embodiment, the nut and bolt assembly may be made with an electrically insulating material. In another embodiment, the bolt may be made of a metal and surrounded by an electrically insulating material. In still another embodiment, the showerhead 106 may be threaded to receive the bolt. In yet another embodiment, the nut may be formed of an electrically insulating material. The electrically insulating material helps to prevent the fastening mechanisms 150 from becoming electrically coupled to any plasma that may be present in the chamber 100.

A gas source 132 is coupled to the backing plate 112 to provide gas through gas passages in the showerhead 106 to a processing area between the showerhead 106 and the substrate 120. A vacuum pump 110 is coupled to the chamber 100 to control the process volume at a desired pressure. An RF source 128 is coupled through a match network 190 to the backing plate 112 and/or to the showerhead 106 to provide an RF current to the showerhead 106. The RF current creates an electric field between the showerhead 106 and the substrate support 118 so that a plasma may be generated from the gases between the showerhead 106 and the substrate support 118. Various frequencies may be used, such as a frequency between about 0.3 MHz and about 200 MHz. In one embodiment, the RF current is provided at a frequency of 13.56 MHz.

A remote plasma source 130, such as an inductively coupled remote plasma source 130, may also be coupled between the gas source 132 and the backing plate 112. Between processing substrates, a cleaning gas may be provided to the remote plasma source 130 so that a remote plasma is generated. The radicals from the remote plasma may be provided to chamber 100 to clean chamber 100 components. The cleaning gas may be further excited by the RF source 128 provided to the showerhead 106. Suitable cleaning gases include but are not limited to NF₃, F₂, SF₆ and Cl₂. The spacing between the top surface of the substrate 120 and the showerhead 106 may be between about 400 mil and about 1,200 mil. In one embodiment, the spacing may be between about 400 mil and about 800 mil.

The backing plate 112 may be supported by a support assembly 138. One or more anchor bolts 140 may extend down from the support assembly 138 to a support ring 144. The support ring 144 may be coupled with the backing plate 112 by one or more fastening mechanisms 142. In one embodiment, the fastening mechanisms 142 may comprise a nut and bolt assembly. In another embodiment, the fastening mechanisms 142 may comprise a threaded bolt coupled with a threaded receiving surface of the backing plate 112. The support ring 144 may be coupled with the backing plate 112 substantially in the center of the backing plate 112. The center of the backing plate 112 is the area of the backing plate 112 with the least amount of support in absence of the support ring 144. Therefore, supporting the center area of the backing plate 112 may reduce and/or prevent sagging of the backing plate 112. In one embodiment, the support ring 144 may be coupled to an actuator that controls the shape of the backing plate 112 so that the center of the backing plate 112 may be raised or lowered relative to the edges of the backing plate 112. The movement of the backing plate 112 may occur in response to a metric obtained during processing. In one embodiment, the metric is the thickness of the layer being deposited. In another embodiment, the metric is the composition of the layer deposited. The movement of the backing plate 112 may occur simultaneous with the processing. In one embodiment, the one or more fastening mechanisms 142 may extend through the backing plate 112 to the showerhead 106.

The showerhead 106 may additionally be coupled to the backing plate 112 by showerhead suspension 134. In one embodiment, the showerhead suspension 134 is a flexible metal skirt. The showerhead suspension 134 may have a lip 136 upon which the showerhead 106 may rest. The backing plate 112 may rest on an upper surface of a ledge 114 coupled with the chamber walls 102 to seal the chamber 100. A chamber lid 152 may be coupled with the chamber walls 102 and spaced from the backing plate 112 by area 154. In one embodiment, the area 154 may be an open space (e.g., a gap between the chamber walls and the backing plate 112). In another embodiment, the area 154 may be an electrically insulating material. The chamber lid 152 may have an opening therethrough to permit the one or more fastening mechanisms 142 to couple with the backing plate 112 and the gas feed conduit 156 to supply processing gas to the chamber 100. In one embodiment, the support ring 144 may be disposed below the chamber lid 152 and substantially centered within the opening of the chamber lid 152.

An RF return plate 146 may be coupled with the ring 144 and the chamber lid 152. The RF return plate 146 may be coupled with the chamber lid 152 by a fastening mechanism 148. In one embodiment, the fastening mechanism 148 comprises a lag screw. The RF return plate 146 may be coupled between the fastening mechanism 142 and the ring 144. The RF return plate 146 provides a return path to the RF source 128 for any RF current that may travel up the fastening mechanism 142 to the ring 144. The RF return plate 146 provides a path for the RF current to flow back down to the chamber lid 152 and then to the RF source 128.

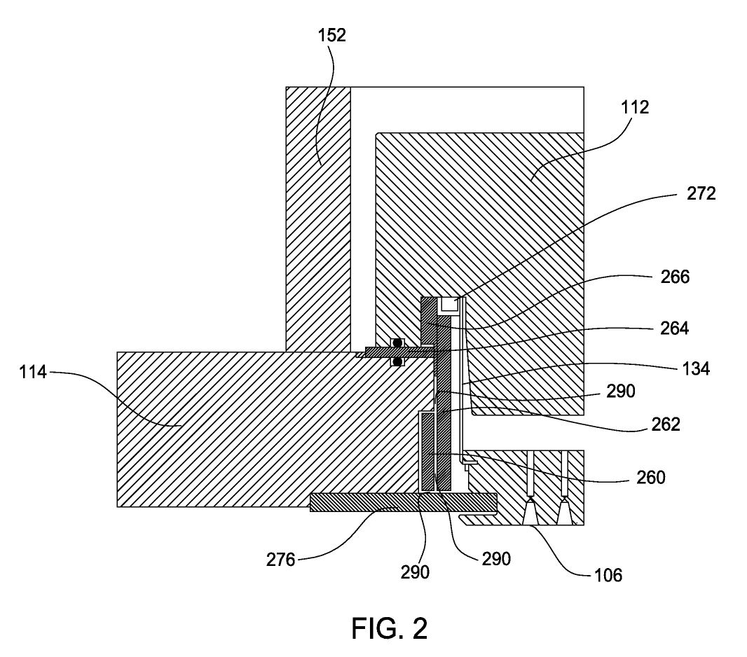

FIG. 2 is a schematic illustration of a backing plate 112 coupled to a showerhead 106. The showerhead suspension 134 is coupled between the backing plate 112 and the showerhead 106. The showerhead suspension 134 is generally made from an electrically conductive material, such as aluminum, in order to electrically couple the showerhead 106 to the backing plate 112. The showerhead suspension 134 is connected to the backing plate 112 by a fastening assembly 272. The fastening assembly 272 may be a threaded bolt, screws or a weld. In one embodiment, the fastening assembly 272 may also include a spring or other tension mechanism.

The backing plate 112 is disposed upon the upper surface of the ledge 114. The ledge 114 is coupled to or is an integral part of the chamber body, and is in electrical communication with chamber walls. The ledge 114 also supports the chamber lid 152 on an upper surface of the ledge 114. The chamber lid 152 and the ledge 114 are also generally in electrical communication with one another.

The ledge 114 is electrically insulated from the backing plate 112 by electrical isolators 260, 262, 264, 266. The electrical isolators 260, 262, 264, 266 may be an electrically insulating material such as polytetrafluoroethylene (e.g., TEFLON® polymer), or may comprise an electrically insulating material coated with polytetrafluoroethylene. Suitable electrically insulating materials for coating may include ceramic, alumina, or other dielectric materials. The electrical isolators 260, 262, and 266 are present to fill voids which assist in minimizing potential arcing. When present, the electrical isolators 260, 262, and 266 may provide electrical isolation between the ledge 114, the showerhead 106 and the backing plate 112. The embodiment of FIG. 2 additionally includes an optional electrical isolator 276. Electrical isolator 276 contacts the ledge 114 and the showerhead 106, and provides electrical isolation therebetween. The electrical isolator 276 may also provide support for the electrical isolators 260 and 262, or may contain process gases from flowing around the showerhead 106 and into undesired regions of the process chamber.

In the embodiment of FIG. 2, spaces 290 are present between the electrical isolators 260, 262, 264, 266, the ledge 114, the backing plate 112, and the electrical isolator 276. The spaces 290 are incorporated in part to allow for thermal expansion during processing. The spaces 290 also create potential locations where arcing and parasitic plasma may form, due to the method in which RF power is applied to the process chamber.

RF power travels throughout a processing system by means of the “skin effect,” e.g., RF current travels over the surface of electrically conductive components. In the embodiment of FIG. 2, RF current flows from an RF source (not shown), over the surface of the backing plate 112 that faces the lid 152, down the surface of the showerhead suspension 134 that faces the electrical isolator 262, and over the surface of the showerhead 106 that faces the processing area. The RF current is then capacitively-coupled through a plasma generated in the processing region of the processing chamber, to the substrate support 118. The RF current then seeks to return to the RF source by traveling down the substrate support 118 or RF return straps 126, and up the chamber body walls to the RF source. RF current flowing from the RF source shall be referred to as “RF hot”, and RF current returning to the RF source shall be referred to as “RF return.”

Since the ledge 114 is coupled to, or is part of the chamber body, the ledge 114 is part of the RF return path. Conversely, the showerhead suspension 134 is “RF hot,” since RF power is being applied from an RF source, across the showerhead suspension 134 to the capacitively coupled plasma in the processing region. The spaces 290 are located between the ledge 114, which is an RF return path, and the showerhead suspension 134, which is RF hot. Thus, an electric potential exists across the spaces 290. Therefore, if process gases are located in the spaces 290, then it is possible for the electric potential across the ledge 114 and the showerhead suspension 134 to arc or form a parasitic plasma within the spaces 290. This is an undesired effect which usurps RF power from the desired process, causing the desired process to be less efficient and more expensive.

With larger processing chambers, such as processing chambers sized to process substrates having a surface area of about 90,000 cm² or greater, there is a narrow RF process window. The narrow RF process window leads to a higher reflected power among processes and higher arc chance within match network at the same power. The narrow process window is due to a very high Q factor, which is defined as Fr/ΔF. Fr is the center frequency and ΔF is the 3 dB bandwidth. A plot of the frequency versus reflected power graph is very sharp when the chamber has a high Q. High Q for reflected power response is not desirable for chambers because high Q leads to a very narrow process window, a high current, a high voltage, a high chance of arcing within the match network, and a high chance for parasitic plasma inside the RPS feedthrough. Large area processing chambers have a very low resistance and high inductance compared to semiconductor equipment. The main reason is due to the large chamber size. Another reason is because the isolator 264 is very thin. This thin isolator 264 leads to a very large stray capacitance in the chamber and leads to very low resistance at the match network output.

When the stray capacitance is decreased, the resistance will increase and consequently Q will decrease by nature. In the same context, increasing the gap between backing plate 112 and the chamber lid 152 or reducing the contact area of the isolator 264 will also lower Q. It has been found that by increasing the thickness (i.e., the distance between the surface of the isolator 264 that touches the ledge 114 and the surface of the isolator 264 that touches the chamber lid 152) of the isolator 264 to greater than 0.190 inches, the real part of impedance is increased and the imaginary part of the impedance is decreased, which leads to lower Q. In the same context, increasing the gaps between the backing plate 112 and the chamber lid 152 or reducing the contact area of isolator 264 are also ways to lower Q.

Lowering Q has several advantages including a wider RF process window (which leads to a wider margin for high power processes) and low reflected power among processes using a frequency tune generator. Additionally, fewer load capacitors are needed in the match network 190, which provides a financial incentive to lowering Q. There is also less chance for arcing due to the lower Q.

Stray capacitance leads to unnecessary current within the match network 190. The stray capacitance will increase current and voltage within the match network 190. Accordingly, stray capacitance leads to arcing. Lowering Q results in a more efficient chamber because unnecessary current will be reduced by stray capacitance reduction and will cause less power dissipation in undesirable locations within the chamber. Lowering Q leads to greater sensitivity for detection because of reduced stray currents.

Plasma Monitoring

RF parameters such as RF voltage, DC voltage, RF current and phase angle are always closely related with plasma conditions. For example, arcing and substrate breakage can be easily detected by observing these parameters in smaller processing chambers, such as those utilized in the semiconductor processing area. Measuring the RF parameters allows the user to predict the film properties. If a plasma condition changes, a corresponding RF parameter changes accordingly. Therefore, obtaining the in-situ RF parameters for detecting in-situ plasma properties is beneficial.

Typically, RF parameter acquisition is done in the match network by detecting the voltage and current of the fundamental frequency. However, as the chamber size is increased, the sensitivity and consistency of RF parameter measurement in match networks is greatly decreased, and accurate RF parameters indicating plasma conditions are much harder to detect. Additionally, the voltage and current of the fundamental frequency in the match network are inconsistent from run to run and chamber to chamber. The voltage and current of the fundamental frequency in the match network are also not sufficiently sensitive for detection of abnormal plasma behavior due to arcing, substrate breakage, or lift pin breakage. Nonlinear plasma movement generates nonlinear harmonic signals by nature. Nonlinear harmonics represent the behavior of plasma more accurately because nonlinear harmonics are generated by the plasma. However, nonlinear harmonics are hard to detect in the match network because nonlinear harmonics are so small.

Strong nonlinear harmonic signals, which are generated by nonlinear plasma behavior and can identify the plasma behavior more accurately, may be detected by moving the location of the measurement to the backing plate. If the RF parameter measurement is performed at a location other than the match network, such as the backing plate, the RF parameters show very strong harmonic signals compared to the fundamental frequency signal measured at the match network. In fact, the harmonic signals measured at the backing plate are strong enough to analyze. Tables I and II each show the RF parameters as measured at the match network (at location 194) and the backing plate (at location 192) respectively. The RF parameters measured at the backing plate show about ten times lower voltage signal as shown when comparing Tables I and II. The processing conditions for depositing the silicon nitride film were a flow rate of about 900 sccm silane, a flow rate of about 10000 sccm N₂, a flow rate of about 3250 sccm NH, a chamber pressure of about 1700 mTorr and a substrate to showerhead spacing of about 1150 mils. The RF parameters as measured at the backing plate permit the use of a low ratio voltage divider. A high ratio voltage divider decreases the sensitivity and increase the SNR (Signal to Noise ratio). Using the low ratio voltage divider, the plasma processing conditions can be detected more accurately. The intensity and phase of each harmonic signal may have more accurate information of the plasma condition. With the RF parameter data obtained at the backing plate, the plasma behavior can be detected more easily and accurately. For example, arcing, substrate breakage or any unexpected abnormal behavior can be readily and more accurately detected.

TABLE I

| | | | | | max-min |
|---|---|---|---|---|---|
| Run | Ave (kV) | Min (kV) | Max (kV) | sdev (V) | difference |
| 1 | 1.888 | 1.86 | 1.92 | 11.6 | 3% |
| 2 | 1.883 | 1.86 | 1.90 | 11.8 | 2% |
| 3 | 1.881 | 1.86 | 1.90 | 12.3 | 2% |
| 4 | 1.860 | 1.84 | 1.92 | 12.4 | 4% |
| 5 | 1.860 | 1.84 | 1.90 | 11.0 | 3% |
| 6 | 1.864 | 1.84 | 1.90 | 11.6 | 3% |
| 7 | 1.861 | 1.82 | 1.89 | 9.9 | 4% |
| 8 | 1.856 | 1.82 | 1.89 | 9.3 | 4% |
| 9 | 1.854 | 1.82 | 1.89 | 9.8 | 4% |
| 10 | 1.853 | 1.82 | 1.89 | 10.6 | 4% |

TABLE II

| | | | | | max-min |
|---|---|---|---|---|---|
| Run | Ave (V) | min (V) | max (V) | sdev (V) | difference |
| 1 | 185 | 182 | 189 | 2.93 | 4% |
| 2 | 176.3 | 171 | 181 | 1.81 | 6% |
| 3 | 175.8 | 170 | 179 | 1.74 | 5% |
| 4 | 174.7 | 170 | 181 | 1.83 | 6% |
| 5 | 173 | 168 | 179 | 1.78 | 6% |
| 6 | 172.7 | 168 | 178 | 1.78 | 6% |
| 7 | 172.3 | 166 | 176 | 1.88 | 6% |
| 8 | 171.7 | 166 | 176 | 1.81 | 6% |
| 9 | 170 | 165 | 176 | 1.81 | 6% |
| 10 | 169.2 | 163 | 176 | 1.81 | 8% |

In regards to RF voltage (V_{rf}) and DC voltage (V_{dc}), both are good references for identifying chamber conditions. When V_{rf} and V_{dc} are different from normal ranges, the V_{rf} and V_{dc} indicate something abnormal, such as arcing, substrate breakage, particles under the substrate, etc., has happened within the chamber. Therefore, sensitive V_{rf} and V_{dc} measurement is highly desirable. However, large area processing chambers have limited response to the abnormal behavior. For example, when the substrate is broken, the V_{rf} and V_{dc} are generally still normal when measured at the match network. But peak to peak voltage (Vₚₚ) and V_{dc} monitoring at the match network is not sensitive enough to detect Vₚₚ and V_{dc}. Vₚₚ and V_{dc} is useful data that may be used to determine the input parameters for the next substrate to be processed within the chamber. RF and DC voltage variation can be so large run to run and chamber to chamber that the Vₚₚ and V_{dc} measurements at the match network cannot be relied upon. A more sensitive measurement is necessary. By measuring the voltage on the backing plate rather than on the match network, the signal is more sensitive, which indicates the in-situ chamber conditions accurately.

Any place on backing plate is a good place for measurement. In one embodiment, the measurement may be taken at the location 192 where the RF voltage couples to the backing plate. In another embodiment, the measurement may be taken at the edge 196 of the backing plate. The edge 196 would be more sensitive because the edge 196 is closer to the plasma. As an example, a broken glass substrate was inserted under an unbroken glass in a processing chamber. The broken glass substrate shows quite a different Vₚₚ and V_{dc} in the same condition when compared to measurement at the when only an unbroken glass substrate is present. For the situation where only the unbroken glass substrate is present, V_{dc} is about −6V and Vₚₚ is about 60V. For the, situation where the broken glass is present under the unbroken glass substrate, V_{dc} is about −35V and Vₚₚ is about 280 V. Thus, the signal when measured at the edge of the backing plate is a strong enough signal to detect in-situ chamber conditions.

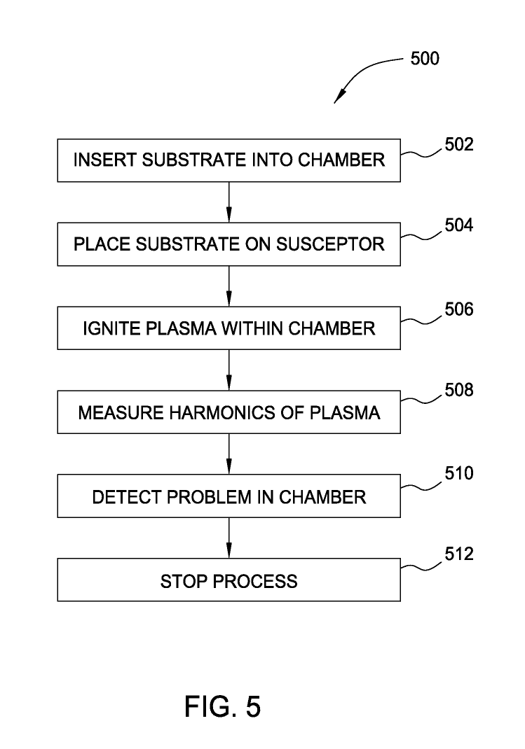

FIG. 5 is a flow chart 500 showing for a method of measuring plasma conditions according to one embodiment. Initially, the substrate is inserted into the processing chamber (502) and placed upon a susceptor (504). The plasma is then ignited within the chamber (506), although it is possible to ignite the plasma remotely and deliver the radicals to the chamber. The harmonics of the plasma are then measured (508) and analyzed. If a problem is detected based upon the harmonics measurement (510), the process is stopped (512) so that the broken ground strap or other issues with the chamber may be corrected. Thus, only the substrate that is presently within the chamber is wasted.

By constantly measuring the various harmonics of the plasma, a more efficient process occurs that minimizes waste. One could imagine a situation where the harmonics are not measured. If the harmonics are not measured, then a whole batch of substrates may be processed using undesired conditions. Wasting a whole batch of substrates would be quite costly in terms of the materials waste and throughput loss. Additionally, if the bad substrates are not recognized timely (i.e., before the product enters the market), potentially lower quality products reach the market that will damage the company's brand and negatively impact future sales.

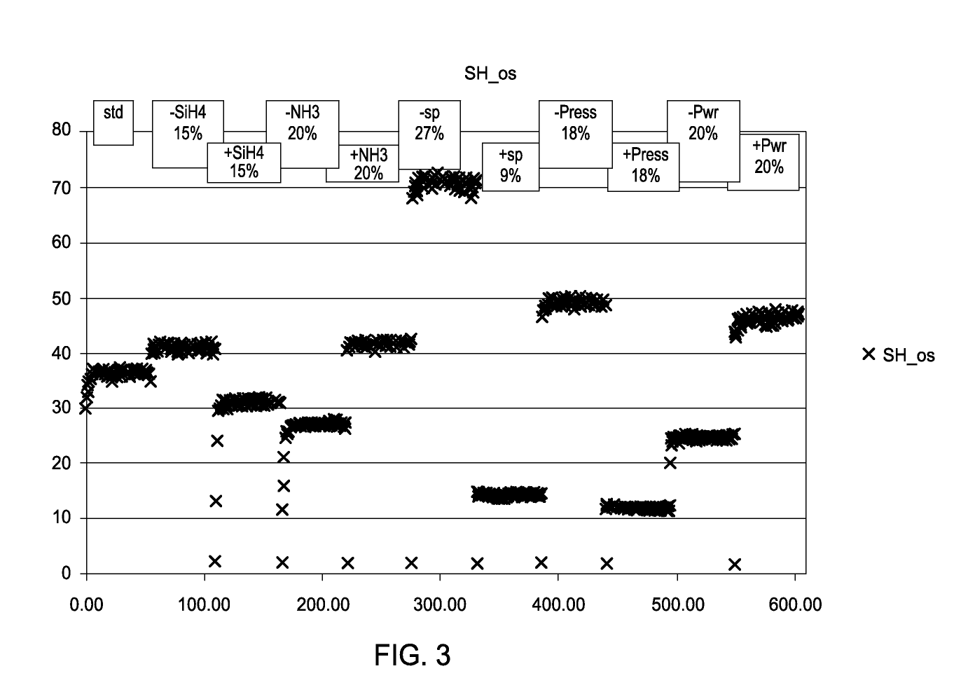

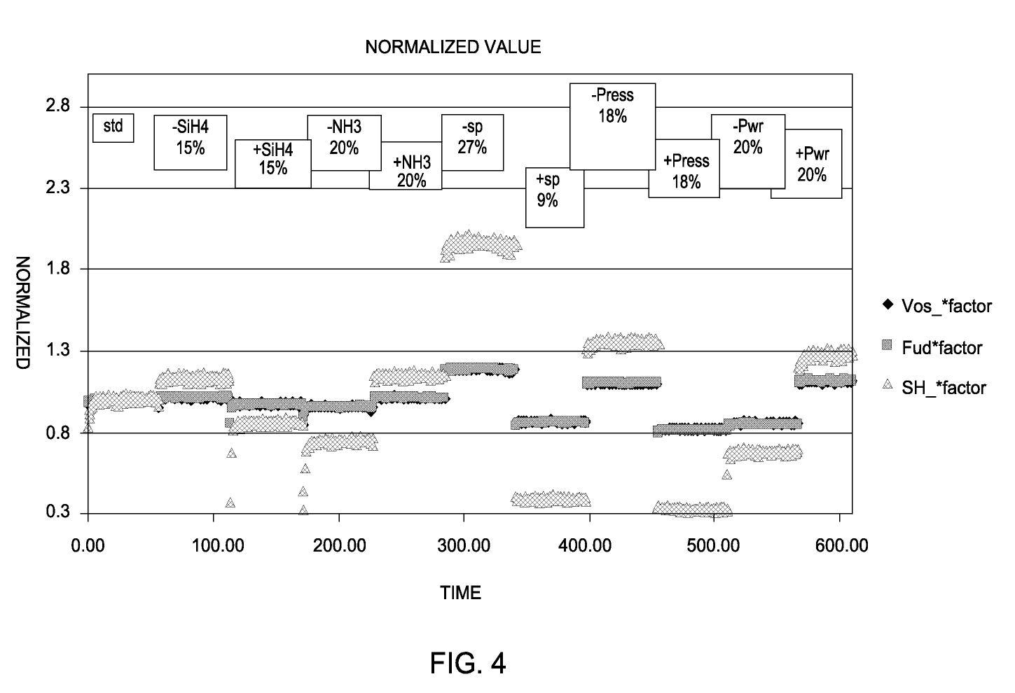

As discussed above, Vₚₚ is very indicative factor for various purposes. In particular, Vₚₚ is known to be a predictive factor empirically for film thickness. Film thickness should be known to effectively anneal a film. For example, when film thickness is larger than anticipated, a higher power should be used for laser annealing the thicker film. Thus, a sensitive and consistent measurement of Vₚₚ is beneficial from process point of view. Large area CCP chambers generate a second harmonic signal by plasma nonlinearity. The sensitivity of the second harmonic voltage shown in FIG. 3 is much sensitive than that of the fundamental frequency or the combined frequency (i.e., fundamental +second harmonic +third harmonic etc. . . . ) shown in FIG. 4. Thus, the film thickness can be predicted much more accurately by monitoring the second harmonic rather than the fundamental frequency.

RF return or ground straps are used in a large area CCP processing chamber to make the susceptor close to reference voltage (0V). If ground strap(s) are broken, the process results, such as uniformity and film properties, are varied and consistent results are difficult to obtain. It is hard to monitor the ground strap during deposition without stopping the process and breaking chamber vacuum. However, the phase of harmonics signal, such as the second harmonic and the third harmonic, are noticeably sensitive to a broken ground strap. Therefore, the ground strap conditions can be confirmed by monitoring the shape of harmonic signal. This phase can be detected during in-situ or ex-situ measurement without breaking chamber vacuum. Tables III and IV show the sensitivity of the second and third harmonics for an unbroken ground strap and a broken ground strap phase for silicon nitride and amorphous silicon respectively. As shown by the tables, both the second harmonic and the third harmonic are sufficiently sensitive to register a phase difference between an unbroken ground strap and a broken ground strap.

TABLE III

| | Unbroken | Broken | | Single run | Run |
|---|---|---|---|---|---|
| | Ground | Ground | | error | to run error |
| | Strap | Strap | Difference | percentage | percentage |
| Second | −136.04 | −49.5 | 24% | 0.90% | 0.70% |
| Harmonic | | | | | |
| Third | 142.73 | −168.6 | 14% | 1.50% | 0.10% |
| Harmonic | | | | | |

TABLE IV

| | Unbroken | Broken | | Single run | Run |
|---|---|---|---|---|---|
| | Ground | Ground | | error | to run error |
| | Strap | Strap | Difference | percentage | percentage |
| Second | −102.8 | −63.1 | 11% | 0.90% | 0.30% |
| Harmonic | | | | | |
| Third | 41.39 | 98.4 | 16% | 2.10% | 0.70% |
| Harmonic | | | | | |

By increasing the thickness of the isolator that is disposed between the backing plate and the ledge of a CCP chamber, and by increasing the distance between the backing plate and the chamber lid, stray capacitance can be reduced or even eliminated. Additionally, by measuring the plasma parameters at locations disposed from the match network, more sensitive and accurate plasma measurements may be taken.

While the foregoing is directed to embodiments of the present invention, other and further embodiments of the invention may be devised without departing from the basic scope thereof, and the scope thereof is determined by the claims that follow.

1. A method, comprising:
delivering RF power from an RF power source through a match network to a backing plate of a capacitively coupled plasma chamber;
igniting a plasma within the capacitively coupled plasma chamber; and
measuring one or more of second and third harmonics of the plasma at a location spaced from the match network.

2. The method of claim 1, further comprising replacing a broken RF return strap in response to the measuring.

3. The method of claim 1, further comprising removing a broken substrate from the capacitively coupled plasma chamber in response to the measuring.

4. The method of claim 1, wherein the location is a center of an electrode of the capacitively coupled plasma chamber.

5. The method of claim 1, wherein the location is an edge of an electrode of the capacitively coupled plasma chamber.

6. A method, comprising:
delivering RF power from an RF power source through a match network to a backing plate of a capacitively coupled plasma chamber;
igniting a plasma within the capacitively coupled plasma chamber; and
detecting a condition of the plasma by measuring a plasma parameter at a location spaced from the match network.

7. The method of claim 6, wherein detecting comprises detecting a second harmonic of the plasma.

8. The method of claim 7, wherein detecting additionally comprises detecting a third harmonic of the plasma.

9. The method of claim 7, wherein the location corresponds to an edge of a backing plate disposed within the chamber.

10. The method of claim 8, further comprising replacing a broken RF return strap in response to the detected condition.

11. The method of claim 7, wherein the location corresponds to a center of a backing plate disposed within the chamber.

12. The method of claim 11, further comprising replacing a broken RF return strap in response to the detected condition.

13. The method of claim 6, wherein detecting comprises detecting a third harmonic of the plasma.

14. The method of claim 13, wherein the location corresponds to an edge of a backing plate disposed within the chamber.

15. The method of claim 14, further comprising replacing a broken RF return strap in response to the detected condition.

16. The method of claim 13, wherein the location corresponds to a center of a backing plate disposed within the chamber.

17. The method of claim 16, further comprising replacing a broken RF return strap in response to the detected condition.

18. The method of claim 6, further comprising replacing a broken RF return strap in response to the detected condition.

19. A plasma enhanced chemical vapor deposition method, comprising:
igniting a plasma within a plasma enhanced chemical vapor deposition chamber, the chamber comprising a matching network, a backing plate and a gas distribution showerhead; and
measuring at least one or second and third harmonics of the plasma generated within the chamber, the measuring occurring at the backing plate.

20. The method of claim 19, further comprising replacing a broken grounding strap in response to the measuring.
